(19) United States
(12) Patent Application Publication
(10) Pub. No.: US 2004/0203597 A1
(43) Pub. Date: Oct. 14, 2004

(54) Mobile subscriber privacy evaluation using solicited vs. unsolicited differentiation

(76) Inventors: Lance Douglas Pitt, Kent, WA (US); Jeff Martin, Seattle, WA (US); Gordon John Hines, Kirkland, WA (US)

Correspondence Address: MANELLI DENISON & SELTER PLLC, Suite 700, 2000 M Street, N.W., Washington, DC, 20036-3307, US

(21) Appl. No.: 10/266,688

(22) Filed: Oct. 9, 2002

Related U.S. Application Data
(60) Provisional application No. 60/367,711, filed on Mar. 28, 2002.
(60) Provisional application No. 60/382,368, filed on May 23, 2002.

(51) Int. Cl. H04M 3/16; H04Q 7/20

(52) U.S. Cl. 455/411; 455/456.1

(57) ABSTRACT

A method and apparatus for providing enhanced privacy to a wireless user comprises implementing an opt`-out privacy policy for solicited requests from at least one given source for private information with respect to a wireless user. An opt-in privacy policy is also implemented for unsolicited requests from at least one given source for private information with respect to the wireless user. A multi-level privacy solution is provided which uses an opt-out policy for solicited service requested directly by the wireless user, and an opt-in policy is provided for unsolicited service not requested directly by the wireless user.

The present application claims priority from U.S. Provisional Application No. 60/367,711, filed Mar. 28, 2002, entitled “Mobile Subscriber Privacy Evaluation Using Solicited vs. Unsolicited Differentiation”, and U.S. Provisional Application No. 60/382,368, filed May 23, 2002, entitled “Location Fidelity Adjustment Based on Mobile Subscriber Privacy Profile”, the entirety of both of which are explicitly incorporated herein by reference.

### BACKGROUND OF THE INVENTION

1. Field of the Invention

This invention relates generally to wireless and long distance carriers, Internet service providers (ISPs), and information content delivery services/providers and long distance carriers. More particularly, it relates to location services for the wireless industry, particularly for E-9-1-1 services.

2. Background of Related Art

Location technology in a wireless world essentially is surveillance technology. When location technology is used to provide services other than emergency services it's necessary to allow the mobile subscriber to control to whom their location may be reported.

Currently, privacy solutions in a wireless carriers network are based on the source of the information. For instance, one conventional solution provides a privacy profile evaluator wherein the wireless user may define the requesting sources to whom location information may be provided.

All competing privacy solutions either use a default “opt-out” (i.e. subscriber's info is disseminated unless explicitly denied by the subscriber) or a default “opt-in” (i.e. subscriber's info is not disseminated unless explicitly allowed by the subscriber). Either option works well in some scenarios, but is very cumbersome in other scenarios.

### SUMMARY OF THE INVENTION

In accordance with the principles of the present invention, a method and apparatus for providing enhanced privacy to a wireless user comprises implementing an opt-out privacy policy for solicited requests for private information with respect to a wireless user. An opt-in privacy policy is also implemented for unsolicited requests for private information with respect to the wireless user. A multi-level privacy solution is provided which uses an opt-out policy for solicited service requested directly by the wireless user, and an opt-in policy is provided for unsolicited service not requested directly by the wireless user.

### BRIEF DESCRIPTION OF THE DRAWINGS

Features and advantages of the present invention will become apparent to those skilled in the art from the following description with reference to the drawings, in which:

FIG. 1 shows a privacy center application including privacy evaluation tables resident in a carrier's wireless intelligent network, in accordance with the principles of the present invention.

FIG. 2 shows exemplary privacy evaluation tables to provide a multi-level privacy solution for solicited and unsolicited requests for private information (e.g., current location) of a wireless user, in accordance with the principles of the present invention.

FIG. 3 shows an exemplary solicited disable list shown in FIG. 2.

FIG. 4 shows an exemplary entity enable list shown in FIG. 2.

FIGS. 5A to 5C show exemplary unsolicited enable lists shown in FIG. 2.

FIG. 6 shows an exemplary process of an opt-in/opt-out two-tiered privacy solution for solicited and unsolicited location requests of a wireless user, using the privacy evaluation tables shown in FIG. 2, in accordance with the principles of the present invention.

### DETAILED DESCRIPTION OF ILLUSTRATIVE EMBODIMENTS

The present invention appreciates that evaluation of a mobile subscriber's privacy should not be just a simple black or white, yes or no answer based solely on the source requesting the privacy information. Rather, the present invention provides module subscribers with the opportunity to add additional dimensions to the release of private information (e.g., presence and/or location).

In accordance with the principles of the present invention, location based wireless services in a service provider's network are commissioned and intertwined with a privacy center to automatically provide a deeper inquisition into the source of the requesting party to provide a balanced approach to the determination of whether or not to allow private information to be disseminated to unsolicited parties in accordance with a strict rule set.

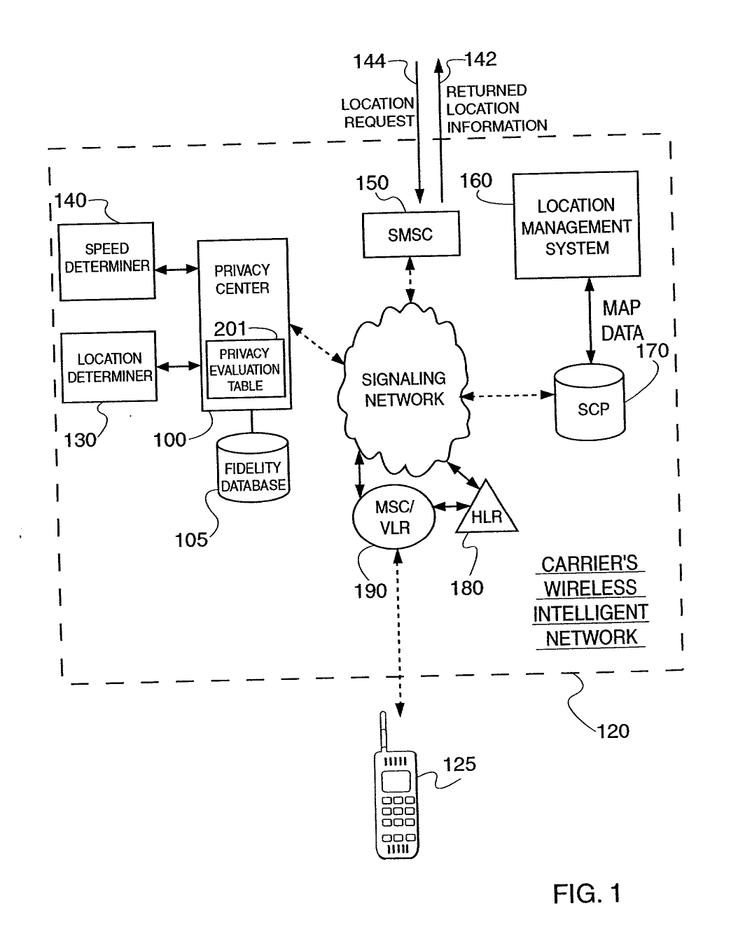

FIG. 1 shows a privacy center application 100 including privacy evaluation tables 201 resident in a carrier's wireless intelligent network, in accordance with the principles of the present invention. The privacy center application 100 may be resident in any of many possible elements in the wireless intelligent network, e.g., in the SCP 170.

Upon receipt of a request for private information, e.g., a request for the location of the subscriber, the wireless network 120 communicates with a location management system 160 and a location determiner 130. The location determiner 130 may determine location using any or all appropriate techniques. Current location determination technology may include the use of, e.g., call/sector ID, angle of arrival (AOA), time difference of arrival (TDOA), and/or time of arrival (TOA), all of which are otherwise known in the art. The present invention is separate from the particular mechanism used to determine location. Thus, any appropriate location determination mechanism may be used in accordance with the principles of the present invention.

Location information may be determined by a centrally located location determiner 130 (or by an individual wireless user 125 e.g., using a GPS device) and provided to the privacy center 100. Additionally, speed information may optionally be determined by the location management system of the wireless network 120, to augment the location information. To this end, a speed determiner 140 may optionally be included to provide rate of movement information regarding the subscriber 125. For instance, the slower the speed of the subscriber, fewer location updates may be required, lessening the burden on the wireless intelligent network 120.

The wireless network 120 of the disclosed embodiments further include a Short Message Service Center (SMSC) 150, a Message Servicing Center (MSC) with Visitors Location Register (VLR) 190 and a Home Location Register (HLR) 180.

The privacy center 100 may be installed on a dedicated computer system, or may be an application loaded on a computer having other responsibilities and tasks within the wireless intelligent network.

In accordance with the principles of the present invention, several tables or lists 201 are maintained for each relevant subscriber (e.g., those subscriber's enjoying the privacy evaluation service of the present invention). Each of the privacy evaluation tables 201 are preferably adjustable by the relevant subscriber, and even more preferably may be adjusted dynamically, e.g., from the wireless device itself on an as-needed basis.

For additional information regarding privacy permission and techniques and apparatus, please refer to U.S. application Ser. No. 60/367,711, filed Mar. 28, 2002, entitled “Mobile Subscriber Privacy Evaluation Using Solicited vs. Unsolicited Differentiation”, the entirety of which is expressly incorporated herein by reference.

Conventional privacy solutions in the wireless world do not differentiate between solicited service requests versus unsolicited service requests. According to the present invention, a multi-level privacy solution is provided which uses an “opt-out” policy for “solicited” service (i.e. service directly requested by the subscriber) and an “opt-in” policy for “unsolicited” service (i.e. service not immediately directly requested by the subscriber). Immediacy in this respect may be, e.g., within a few seconds or minutes of request by subscriber, intended to capture the case where the subscriber is somehow interacting with the device.

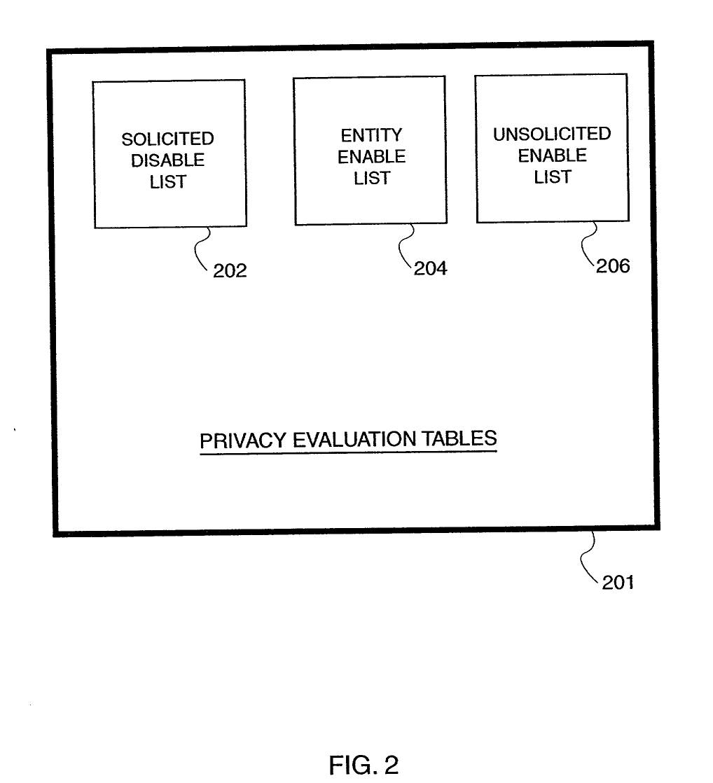

FIG. 2 shows exemplary privacy evaluation tables 201 suitable to provide a multi-level privacy solution for solicited and unsolicited requests for private information (e.g., current location) of a wireless user, in accordance with the principles of the present invention.

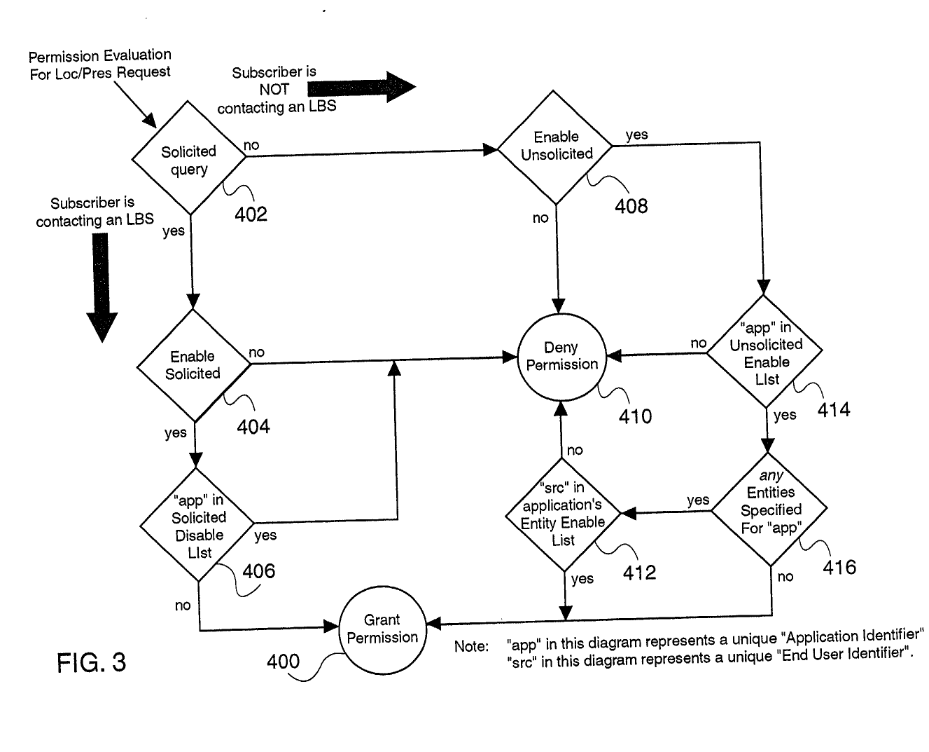

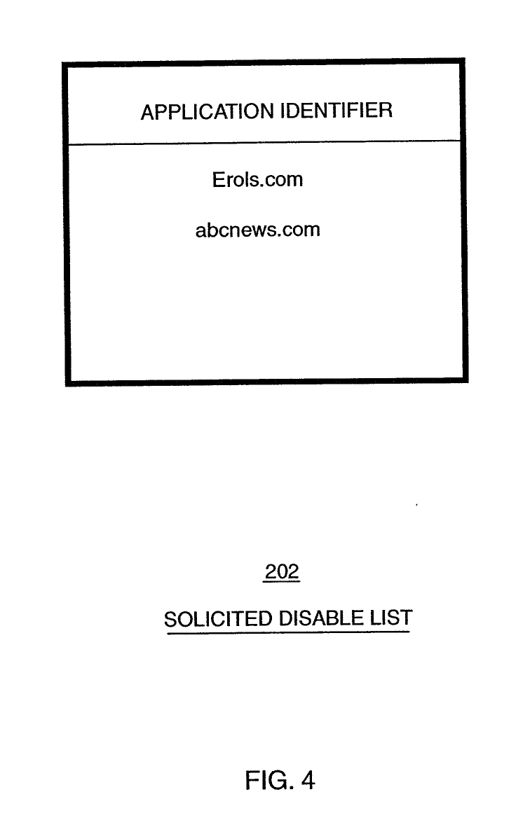

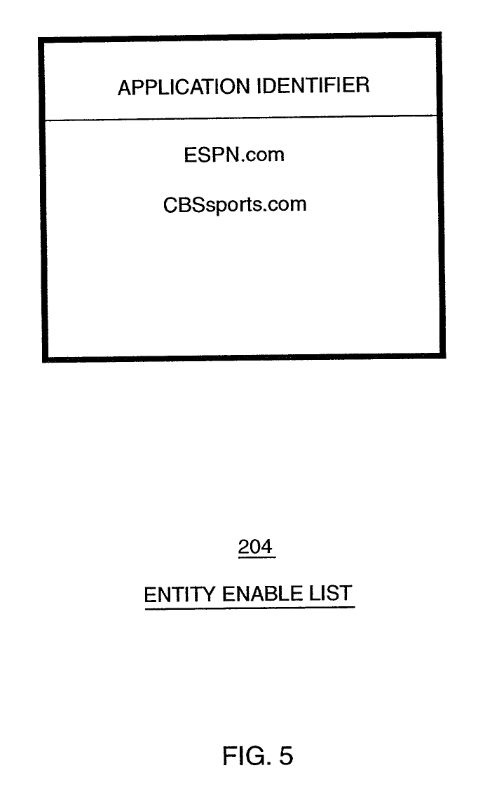

In particular, FIG. 2 shows suitable privacy evaluation tables 201 comprising, e.g., a solicited disable list 202, an entity enable list 204, and an unsolicited enable list 206. An exemplary solicited disable list 202 is further detailed as an example in FIG. 3, an exemplary entity enable list 204 is further detailed in FIG. 4, and several examples of unsolicited enable lists 206 are detailed in FIGS. 5A to 5C.

FIGS. 5A to 5C show flexibility that may be incorporated into the tables or lists. For instance, if the phrase “any” appears in the list at any point, the process may permit any requesting application to receive the requested private information. This simplifies the maintenance of the particular list, maintaining the prior entries (which may have taken a considerable amount of time to develop/enter) until which time the user may simply remove the “any” entry and revert back to the detailed list of application identifiers. The same feature may be incorporated in the opposite in another table or list, e.g., using a phrase such as “none” to enable no application identifiers to receive private information.

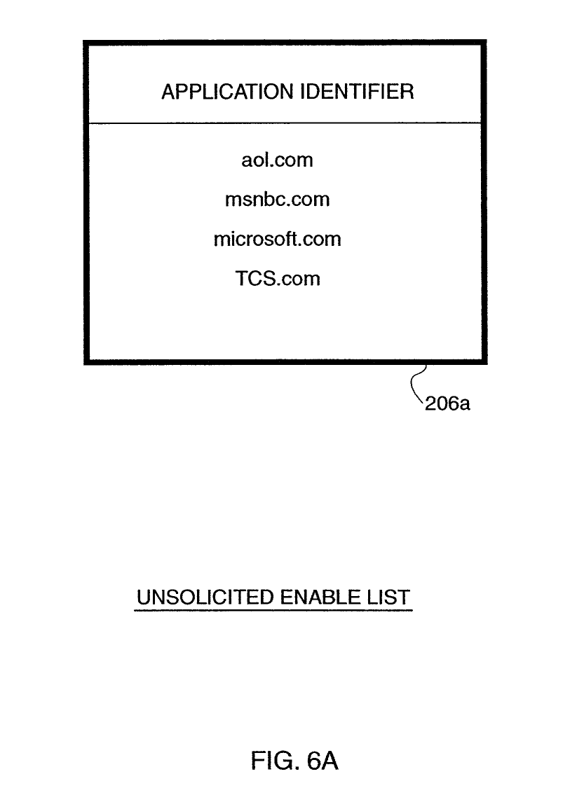

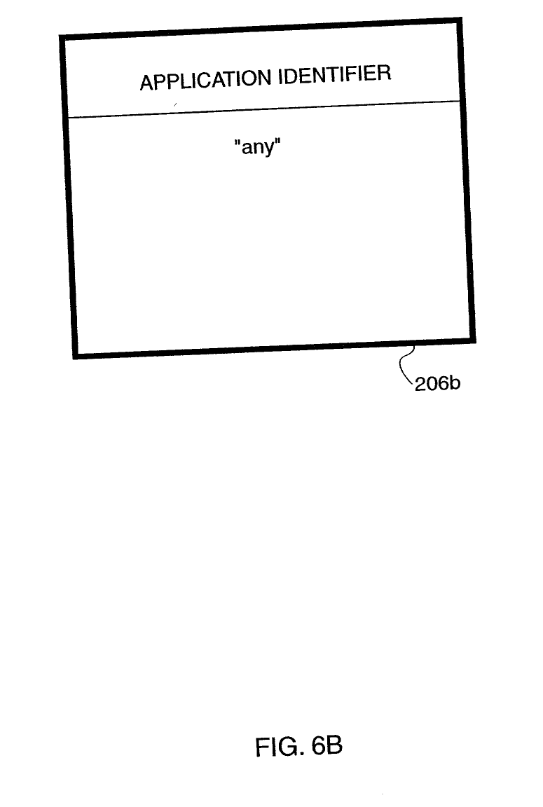

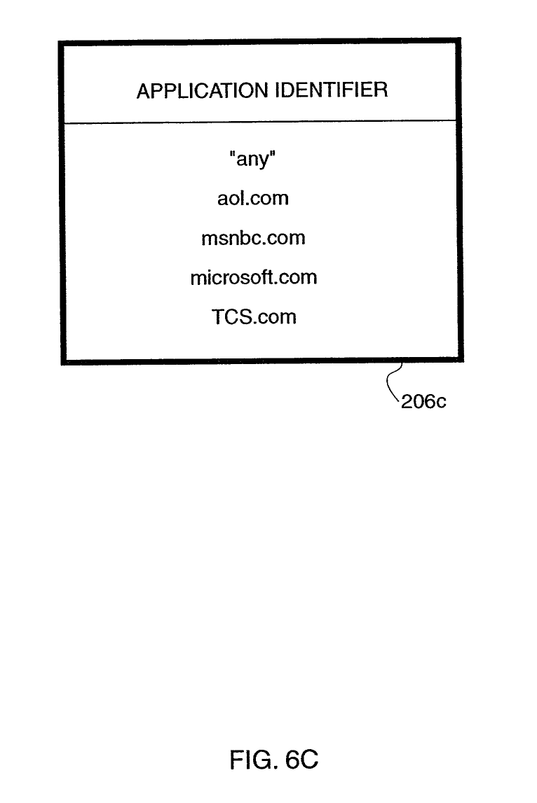

FIG. 6 shows a process of an opt-in/opt-out two-tiered privacy solution for solicited and unsolicited location requests of a wireless user, using the privacy evaluation tables 201 shown in FIG. 2, in accordance with the principles of the present invention.

In particular, a privacy center application 100 is implemented which follows the process shown in FIG. 6. The privacy center 100 in accordance with the principles of the present invention requires that service requests identify whether or not they originate from direct interaction with a mobile subscriber. Service requests that stem from direct interaction with the mobile subscriber are called “Solicited” requests. Service requests that do not stem from direct interaction with the mobile subscriber are called “Unsolicited” requests.

The privacy center 100 utilizes an “opt-out” policy for Solicited requests. This means that the mobile subscriber must explicitly deny the dissemination of their information to specific parties. These parties are limited to businesses. The privacy center 100 maintains a list of specific parties to whom the mobile subscriber has denied the solicited dissemination of information. The privacy center 100 checks that list every time a solicited request is received for the mobile subscriber's information. If the requester is NOT on the list then the mobile subscriber's information is disseminated. If the requestor IS on the list then the request for information is denied.

The privacy center 100 utilizes an “opt-in” policy for Unsolicited requests. This means that the mobile subscriber must explicitly allow the dissemination of their information to specific parties. These parties may include individuals or businesses. The privacy center 100 maintains a list of specific parties to whom the mobile subscriber has allowed the unsolicited dissemination of information. The privacy center 100 checks that list every time an unsolicited request is received for the mobile subscriber's information. If the requestor IS on the list then the mobile subscriber's information is disseminated. If the requestor is NOT on the list then the request for information is denied.

The privacy center 100 provides a switch with which a mobile subscriber can disable all solicited requests and another switch with which the mobile subscriber can disable all unsolicited requests. If solicited requests are disabled then all solicited requests are denied. If unsolicited requests are disabled then all unsolicited requests are denied.

The privacy center 100 also provides database tables with which customer carriers can initialize some aspects of a new subscriber's privacy profile. This capability is provided to allow customer carriers to configure the system to closely meet the needs of their customer base.

Use of an “opt-out” privacy policy for solicited requests and an “opt-in” privacy policy for unsolicited requests in accordance with the present invention creates a very clean initial state for both new mobile subscribers AND new customer carriers. In both cases all the privacy database tables are empty. This allows new mobile subscribers to utilize location enabled services by calling the service (i.e. soliciting the service) without first having to log in to a web site and add the service provider to an “enable” list. This initial state also prevents the mobile subscriber's information from being passed to anyone without the mobile subscriber's interaction.

While the invention has been described with reference to the exemplary embodiments thereof, those skilled in the art will be able to make various modifications to the described embodiments of the invention without departing from the true spirit and scope of the invention.

What is claimed is:

1. A method of providing enhanced privacy to a wireless user, comprising:
implementing an opt-out privacy policy for solicited requests for private information with respect to a wireless user; and
implementing an opt-in privacy policy for unsolicited requests for private information with respect to said wireless user;
wherein a multi-level privacy solution is provided which uses an opt-out policy for solicited service requested directly by said wireless user, and an opt-in policy for unsolicited service not requested directly by said wireless user.

2. The method of providing enhanced privacy to a wireless user according to claim 1, wherein:
said private information includes a current location of said wireless user.

3. The method of providing enhanced privacy to a wireless user according to claim 1, further comprising:
implementing an entity enable policy for enabling at least one unsolicited request from a given source.

4. The method of providing enhanced privacy to a wireless user according to claim 3, wherein:
said private information includes a current location of said wireless user.

5. Apparatus for providing enhanced privacy to a wireless user, comprising:
means for implementing an opt-out privacy policy for solicited requests from at least one given source for private information with respect to a wireless user; and
means for implementing an opt-in privacy policy for unsolicited requests from at least one given source for private information with respect to said wireless user;
wherein a multi-level privacy solution is provided which uses an opt-out policy for solicited service requested directly by said wireless user, and an opt-in policy for unsolicited service not requested directly by said wireless user.

6. The apparatus for providing enhanced privacy to a wireless user according to claim 5, wherein:
said private information includes a current location of said wireless user.

7. The apparatus for providing enhanced privacy to a wireless user according to claim 5, further comprising:
means for implementing an entity enable policy to enable at least one unsolicited request from a given source.

8. The apparatus for providing enhanced privacy to a wireless user according to claim 7, wherein:
said private information includes a current location of said wireless user.

9. The apparatus for providing enhanced privacy to a wireless user according to claim 5, wherein:
said means for implementing said opt-in policy includes an unsolicited enable list.

10. The apparatus for providing enhanced privacy to a wireless user according to claim 5, wherein:
said means for implementing said opt-out policy includes a solicited disable list.

11. The apparatus for providing enhanced privacy to a wireless user according to claim 10, wherein:
said means for implementing said opt-in policy includes an unsolicited enable list.

12. The apparatus for providing enhanced privacy to a wireless user according to claim 5, further comprising:
an entity enable list.
